(19) United States
(12) Patent Application Publication
(10) Pub. No.: US 2005/0138004 A1
(43) Pub. Date: Jun. 23, 2005

(54) Link modification system and method

(75) Inventors: Alik Teplitsky, Afula (IL); Avihai Lifschitz, Zichron-Yaakov (IL); Dekel Israeli, St. Ashdod (IL); Ehud Soen, Haifa (IL); Oren Trutner, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/738,362

(22) Filed: Dec. 17, 2003

(51) Int. Cl. G06F 7/00

(52) U.S. Cl. 707/3

(57) ABSTRACT

A system receives a request for an internal web page from an external browser application. At least one internal link in the internal web page is identified. The internal link is modified so that the internal link is accessible by the external browser application. The requested web page, including the modified internal link, is communicated to the external browser application.

### TECHNICAL FIELD

The systems and methods described herein relate to modifying links in a document such as a web page.

### BACKGROUND

Computer systems are continuing to grow in popularity for business-related uses as well as personal or individual uses. In an organizational setting, computer systems are frequently interconnected with other computer systems via networks, such as local area networks (LANs), wide area networks (WANs) and the Internet. Features such as electronic mail (email), instant messaging, and remote access of organizational servers encourage the use of computer systems coupled to networks. These features allow users to, for example, communicate with other users and retrieve various content, such as documents, product information, and audio or video content.

Entities, such as businesses and other organizations, often utilize an internal (or private) network such as an “intranet”. These internal networks do not typically use the public domain name of the organization. A public domain name is a name that can be resolved over the Internet DNS (Domain Name Service) system. Public domain names often resolve to public IP (Internet Protocol) addresses. Example domain names include microsoft.com, acme.com, or stateuniversity.edu.

Access to internal networks and internal web sites can be made available to users via the Internet (or other data communication network) through a corporate firewall or other mechanism. To accesses an internal web site (or internal web page) via the Internet, the internal web site is assigned a public URL (Uniform Resource Locator). A user is able to access the internal web site via the Internet using the public URL. However, problems occur when a user accessing the internal web site via the Internet activates a link to another internal web site (or another internal web page). This internal link does not contain the proper information for an external application (such as a web browser) to access the appropriate internal web site. For example, an internal web site “http://benefits” may have a corresponding public URL “http://www.acme.com/benefits”. If a user activates a link embedded in the internal web site to “http://benefits/insurance”, an error message is generated because the link is not a valid public IP address (e.g., the link does not contain the public domain name). Further, the internal web site and the corresponding public web site may contain different data in the path names or other variations that prevent the internal web site from being accessed via the Internet.

It would be desirable to provide for the proper handling of links to internal web sites by devices or application programs accessing an internal network via an external network.

### SUMMARY

The systems and methods described herein modify an internal link in a document, such as a web page, to allow the document to be accessed by an external application or device. In a particular embodiment, a process receives a request for an internal web page from an external browser application. The process identifies at least one internal link in the internal web page and modifies the internal link so that the internal link is accessible by the external browser application. The requested web page, including the modified internal link, is then communicated to the external browser application.

### BRIEF DESCRIPTION OF THE DRAWINGS

Similar reference numbers are used throughout the figures to reference like components and/or features.

FIG. 1 illustrates an example internal web page that contains links to other web pages on a common intranet.

FIG. 2 illustrates an example environment capable of implementing a link translation process.

FIG. 3 illustrates another example environment capable of implementing a link translation process.

FIG. 4 illustrates an example link translation table maintained by a server or other device in a network.

FIG. 5 is a flow diagram illustrating an embodiment of a procedure for adding string mappings and other translation rules or parameters to a link translation table.

FIG. 6 is a flow diagram illustrating an embodiment of a procedure for translating links associated with one or more internal web sites.

FIG. 7 illustrates a general computer environment, which can be used to implement the techniques described herein.

### DETAILED DESCRIPTION

The systems and methods discussed herein modify links associated with an internal web site or web page such that an external application or device can access the internal web site or web page. Links associated with internal web sites or web pages are translated using information contained in a link translation table. The translated links are provided to the external application or device requesting access to the web site or web page associated with the link. These systems and methods allow external access to internal web pages without having to maintain separate versions of web pages (e.g., an internal version and an external version). Further, the systems and methods discussed herein allow external access to internal web pages without requiring the external application or device to have knowledge of the internal link naming structure or the link translation process.

These systems and methods intercept web pages from internal web sites and replace any links that would not work correctly when accessed via the Internet with properly translated links. For example, link translation can replace the following types of links.
1. Absolute links to web pages on the same internal web site. For example, a link to “http://windows” is replaced with a link to “http://www.microsoft.com/windows”.
2. Absolute links that reference a protocol different than the protocol used over the Internet. For example, if the public web site uses HTTPS, but the internal web site uses HTTP, a link to “http://windows” is replaced with a link to “https://www.microsoft.com/windows”.
3. Absolute links to other internal web sites that are available through a common firewall.

Although particular examples discussed herein refer to translating links contained in internal web pages, alternate embodiments may process any type of link or other data contained in any type of web page, document, or other collection of data. Additionally, the examples discussed herein refer to an intranet as an “internal network” and the Internet as an “external network”. In alternate embodiments, any network (or portion of a network) may be the “internal network” and any other network (or portion of a network) may be the “external network”. Further, one portion of a network may be the “internal network” and another portion of the same network may be the “external network”.

In example embodiments discussed herein, an intranet is also referred to as an “internal network”. An “intranet” refers to a private (or internal) network of a company, organization, or other entity. An “intranet web site” or “internal web site” is a web site installed on an intranet that serves content (e.g., web pages) to computers and other devices coupled to that intranet. A “public IP address” refers to an IP address that can be reached via the Internet. A “public domain name” refers to a domain name that can be resolved over the Internet DNS system. Public domain names may resolve to public IP addresses. A “public URL” is a web page URL that contains a public domain name or a public IP address and, thus, is accessible via the Internet. An “internal IP address” is an IP address that can be reached via an intranet or other private internal network of an entity. An “internal domain name” is a domain name that can be resolved over the intranet or other private network of the entity. Internal domain names may resolve to internal IP addresses. An “internal URL” is a web page URL that contains an internal domain name and, thus, is accessible via the intranet or other private internal network of the entity. An “absolute URL” is a URL that contains a domain name, such as “http://www.microsoft.com/windows/new”. A “relative URL” is a URL that references a path relative to the page that contains it, such as “windows/new”. A “root-relative URL” is a URL that references a path relative to the root of the web site that contains it, such as “/windows/new”.

As used herein, “link modification” may also be referred to as “link translation”, “link conversion”, or “link alteration”. Link modification may also be referred to as “document modification”. Additionally, the terms “public site”, “public link” and “public page” may also be referred to as “external site”, “external link” and “external page”, respectively. The terms “private site”, “private link” and “private page” may also be referred to as “internal site”, “internal link” and “internal page”, respectively.

Additionally, the term “web page” includes any data (e.g., a document or collection of information) available via any network or other system. For example, a web page may be available via an internal network, an external network, or a combination of an internal network and an external network. As used herein, a web page is not necessarily publicly accessible via the Internet or other data communication network.

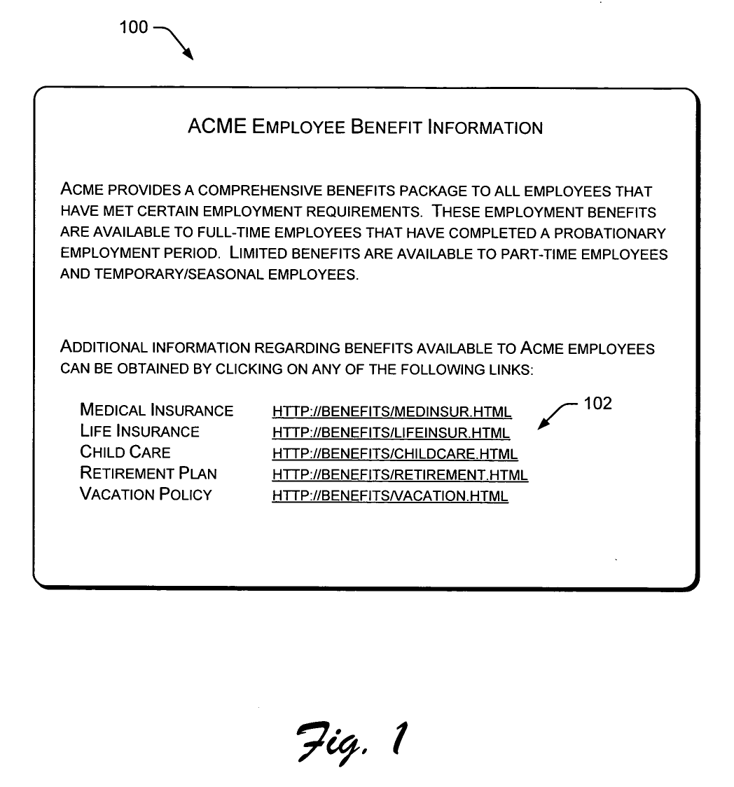

FIG. 1 illustrates an example internal web page 100 that contains links to other web pages on a common intranet. In this example, web page 100 is accessible via an internal web site as well as an external web site, such as the Internet. In one example, the internal URL is “http://benefits” and the corresponding external URL is “http://www.acme.com/benefits”. Thus, web page 100 can be accessed internally and externally.

Web page 100 contains several internal links 102 associated with other internal web pages, such as “http://benefits/childcare.html”, which is a web page associated with child care benefits. An application, such as a web browser, accessing web page 100 via the intranet can successfully activate any of the internal links 102 and be shown the appropriate web page. But, applications or devices accessing web page 100 via the Internet (or any other network external to the intranet) cannot successfully activate the internal links 102 because those internal links do not contain a full public URL. However, as discussed herein, internal links 102 are translated, using information contained in a link translation table, into public URLs that allow external applications or devices to access the web pages associated with internal links 102. The stored information representing web page 100 is not modified during the link translation process. Instead, the internal links 102 are translated as web page 100 is communicated to the requesting application or device, such that the translated links are communicated to the requesting application or device instead of the original internal links 102.

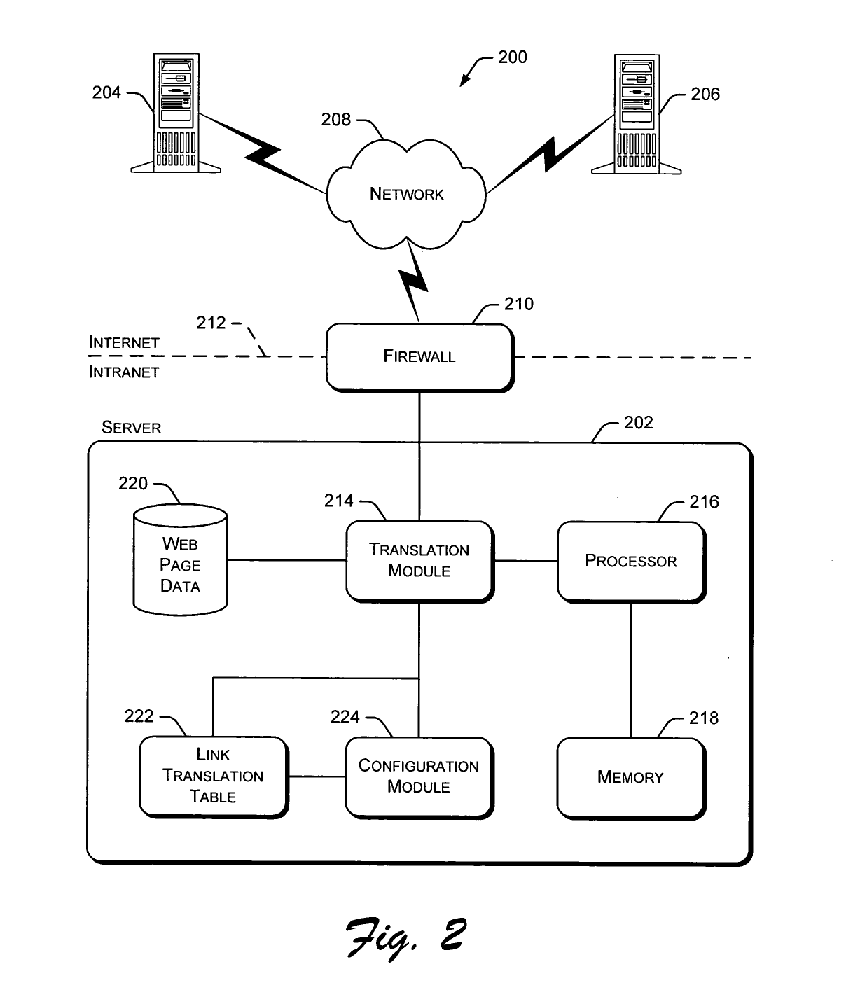

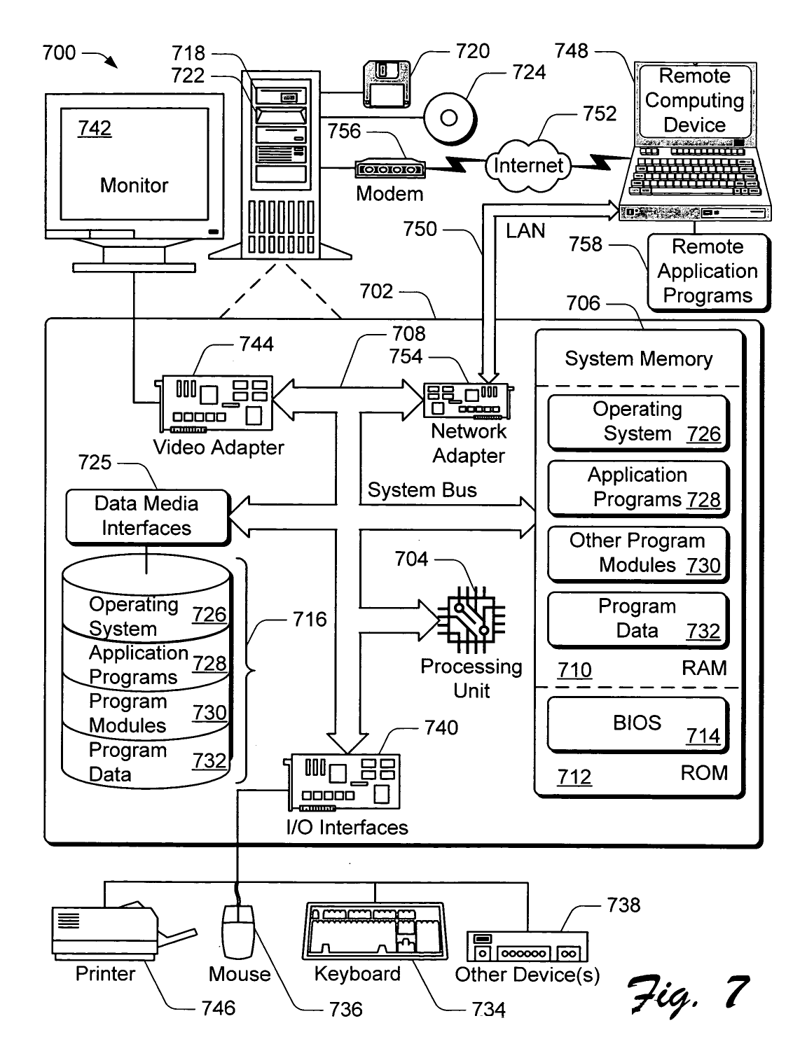

FIG. 2 illustrates an example environment 200 capable of implementing a link translation process. A server 202 is coupled to multiple computing devices 204 and 206 via a network 208. Although computing devices 204 and 206 are shown as computer workstations, computing devices 204 and 206 may be laptop computers, handheld computers, personal digital assistants (PDAs), cellular phones, set top boxes, game consoles, or other types of computing devices. Similarly, server 202 can be any type of computing device, such as the device discussed below with respect to FIG. 7. Although FIG. 2 illustrates server 202 being coupled to two computing devices 204 and 206, server 202 may be coupled to any number of computing devices, servers, or other devices capable of communicating with server 202.

Network 208 can be any type of data communication network, such as a local area network (LAN), wide area network (WAN), the Internet, and the like. In the examples discussed herein, network 208 is referred to as the Internet. Server 202 is coupled to network 208 via a firewall 210. A broken line 212 identifies the separation of the public Internet from the private intranet (or private network) to which server 202 is coupled. Firewall 210 is a barrier between the Internet and the intranet, and is intended to prevent unauthorized access to server 1202 and other devices coupled to the intranet. Firewall 210 monitors data flowing from the Internet to the intranet and blocks certain data or requests to protect the intranet. Firewall 210 also monitors data flowing from the intranet to the Internet and translates internal links into external links, as needed. Firewall 210 can be implemented in hardware, software, or a combination of hardware and software. Firewall 210 can be a single device or a combination of two or more devices working together to prevent unauthorized access to the intranet. In alternate embodiments, firewall 210 is contained in a server, such as server 202.

Server 202 includes a translation module 214 that handles various link translation procedures, such as translating internal links to external links. Translation module 214 is coupled to firewall 210 as well as a processor 216, a web page data store 220, a link translation table 222 and a configuration module 224. Translation module 214 may also handle other data conversion and link translation functions. Processor 216 performs various processing activities necessary for the operation of server 202. A memory device 218 is coupled to processor 216. Memory device 218 stores various data generated by and/or used by processor 216 as it performs the various processing activities. Additional details regarding processor 216 and memory device 218 are discussed below with reference to FIG. 7.

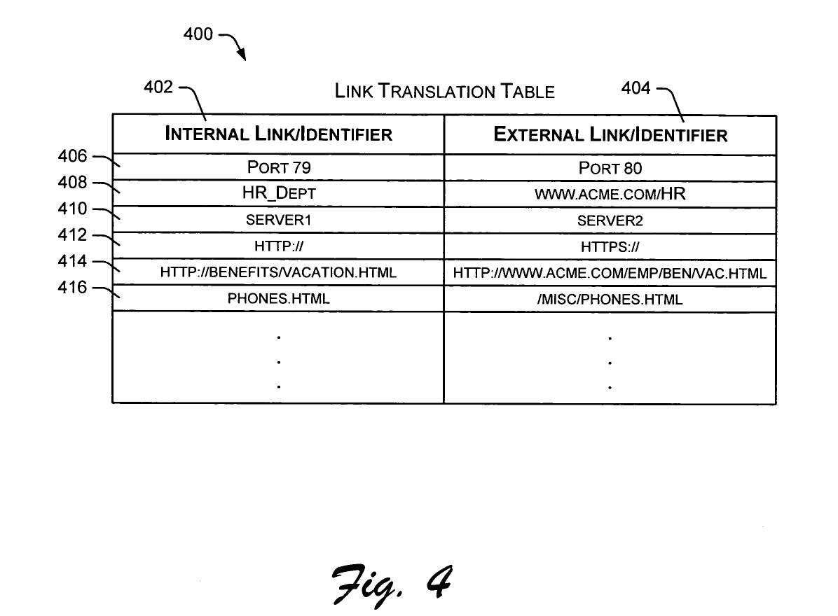

Translation module 214 obtains web page information from web page data store 220 and translates any local links contained in the web page information before providing the web page information to firewall 210. Web page data store 220 contains web page information for any number of different web pages. Link translation table 222 contains information related to translating internal links into external links that allow external applications or devices to access web pages associated with the internal links. The information contained in link translation table 222 is used by translation module 214 in translating links contained in web pages. Configuration module 224 is used by an administrator or other operator to define certain link translation rules or other link translation information. The link translation rules (or link translation information) are stored in link translation table 222 for use by translation module 214. Additional details regarding link translation table 222, and the information contained therein, are discussed below with respect to FIG. 4.

Translation module 214 and configuration module 224 may be implemented in software, hardware, or a combination of software and hardware. Additionally, a particular intranet may include any number of servers 202 and any number of firewalls 210 coupled to one another. For example, an intranet may include multiple servers coupled to a single firewall, such that the firewall processes all data flowing between the Internet and any of the servers in the intranet. In this embodiment, a particular server (or group of servers) may be responsible for performing link translation functions. Thus, it is not necessary for each server to contain a translation module 214 and a link translation table 222.

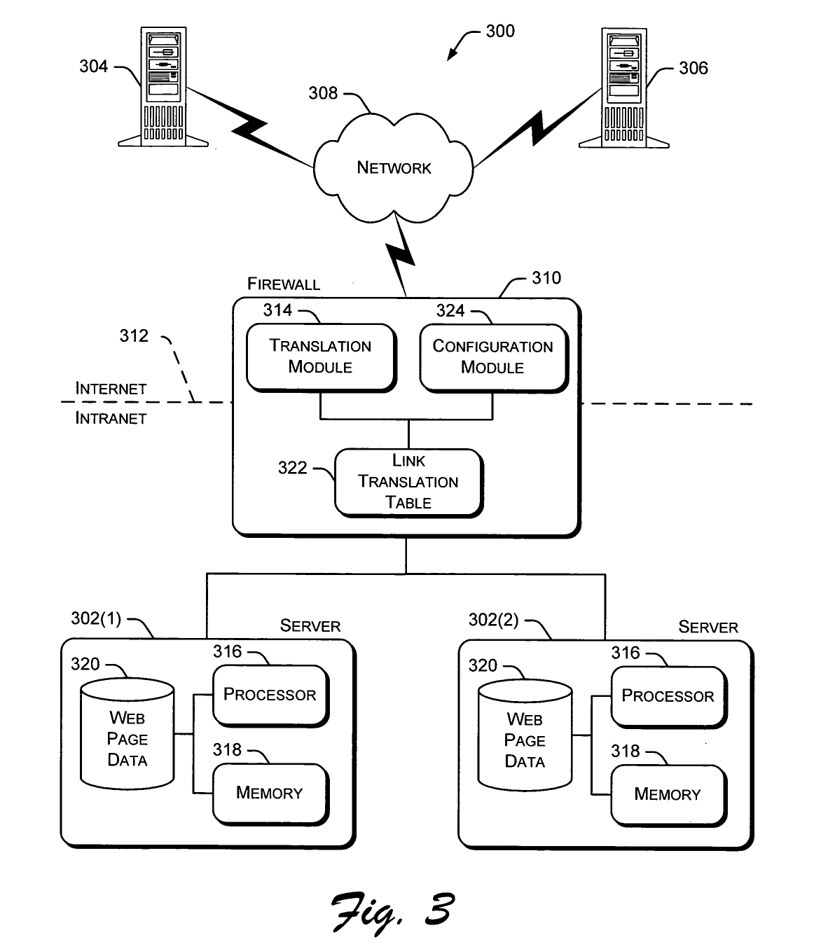

FIG. 3 illustrates another example environment 300 capable of implementing a link translation process. In this embodiment, the translation module, link translation table and configuration module are contained in a firewall rather than in a server (as shown in FIG. 2). A firewall 310 is coupled to multiple servers 302 and coupled to multiple computing devices 304 and 306 via a network 308. Servers 302 and computing devices 304 and 306 may be any type of computing device, such as the device discussed below with respect to FIG. 7. Although FIG. 3 illustrates two servers 302 coupled to firewall 310, any number of servers 302 may be coupled to firewall 310. Further, alternate embodiments of environment 300 may include any number of firewalls 310 coupled to any number of servers 302 and any number of networks 308.

Network 308 can be any type of data communication network, such as a LAN, WAN, the Internet, and the like. In the examples discussed below, network 308 is referred to as the Internet. Servers 302 are coupled to network 308 via firewall 310. A broken line 312 identifies the separation of the public Internet from the private intranet (or private network) to which servers 302 are coupled. Firewall 310 is a barrier between the Internet and the intranet, and is intended to prevent unauthorized access to servers 302 and other devices coupled to the intranet. For example, firewall 310 monitors data flowing from the Internet to the intranet and blocks certain data or requests to protect the intranet. Firewall 310 also monitors data flowing from the intranet to the Internet and translates internal links into external links, as needed. Firewall 310 can be implemented in hardware, software, or a combination of hardware and software. Firewall 310 can be a single device or a combination of two or more devices working together to prevent unauthorized access to the intranet.

Firewall 310 includes a translation module 314 that handles various link translation procedures, such as translating internal links to external links. Translation module 314 may also handle other data conversion and link translation functions. Translation module 314 is coupled to a link translation table 322 and a configuration module 324. Link translation table 322 contains information related to translating internal links into external links that allow external applications or devices to access web pages associated with the internal links. The information contained in link translation table 322 is used by translation module 314 to translate links contained in web pages. Configuration module 324 is used by an administrator or other operator to define certain link translation rules or other link translation information. The link translation rules (or link translation information) are stored in link translation table 322 for use by translation module 314. Additional details regarding link translation table 322, and the information contained therein, are discussed below with respect to FIG. 4.

Each server 302 includes a processor 316, a memory device 318 and a web page data store 320. Alternate embodiments of server 302 may omit the web page data store 320 (e.g., for servers that are not responsible for processing web pages). Processor 316 performs various processing activities necessary for the operation of server 302. Memory device 318 stores various data generated by and/or used by processor 316 as it performs the various processing activities. Additional details regarding processor 316 and memory device 318 are discussed below with reference to FIG. 7.

In operation, translation module 314 obtains web page information from one or more web page data stores 320 and translates any local links contained in the web page information before providing the web page information to a requesting application program or computing device. Translation module 314 and configuration module 324 may be implemented in software, hardware, or a combination of software and hardware.

FIG. 4 illustrates an example link translation table 400 maintained by a server or other device in a network. In one embodiment, link translation table 400 is stored in a server, such as server 202 in FIG. 2. Alternatively, link translation table 400 may be stored in another device or component, such as firewall 310 in FIG. 3. In one embodiment, link translation table 400 is stored in the same device or component as the translation module that accesses link translation table 400. However, in alternate embodiments, link translation table 400 and the translation module that accesses the link translation table are located in different devices or components.

A first column 402 of link translation table 400 identifies strings of characters (or other identifiers) associated with an entire internal link or a portion of an internal link. A second column 404 of link translation table 400 identifies additional strings of characters (or other identifiers) associated with an entire external link or a portion of an external link. Strings in the same row of link translation table 400 represent translations that are applied to internal links to make those internal links accessible externally (e.g., via the Internet). For example, a row 406 indicates that an internal link containing a reference to port 79 should be translated to an external link containing a reference to port 80. A row 408 indicates that an internal link containing a string “HD_Dept” should be translated to “www.acme.com/HR”. Thus, an internal link “http://HR_Dept” would be translated to an external link “http://www.acme.com/HR”.

A row 410 in link translation table 400 indicates that internal links containing a reference to “server1” are translated to external links containing a corresponding reference to “server2”. A row 412 indicates a change in protocol indicators—any internal links containing a string “http://” are translated to external links containing a replacement string “https://”. The strings “http://” and “https://” are also referred to as “protocol designators” or “protocol indicators”. Rows 414 and 416 illustrate additional examples of particular strings that are translated between internal links and external links.

A particular link translation table 400 may include any number of entries (e.g., rows). These entries may be defined by an administrator or other user, or may be defined by a link translation module, as discussed below. In the embodiment of FIG. 4, user-defined entries and entries defined by the link translation module are stored in the same link translation table 400. In alternate embodiments, user-defined entries may be stored in one link translation table and entries defined by the link translation module are stored in a second link translation table. In particular embodiments, other components, devices, or modules may generate one or more entries contained in link translation table 400.

FIG. 4 illustrates one embodiment of a link translation table structure. In alternate embodiments, any type of data structure or data storage arrangement may be used to store various information used in translating one or more links. For example, arrays, hash tables, or binary trees can store information used in translating links.

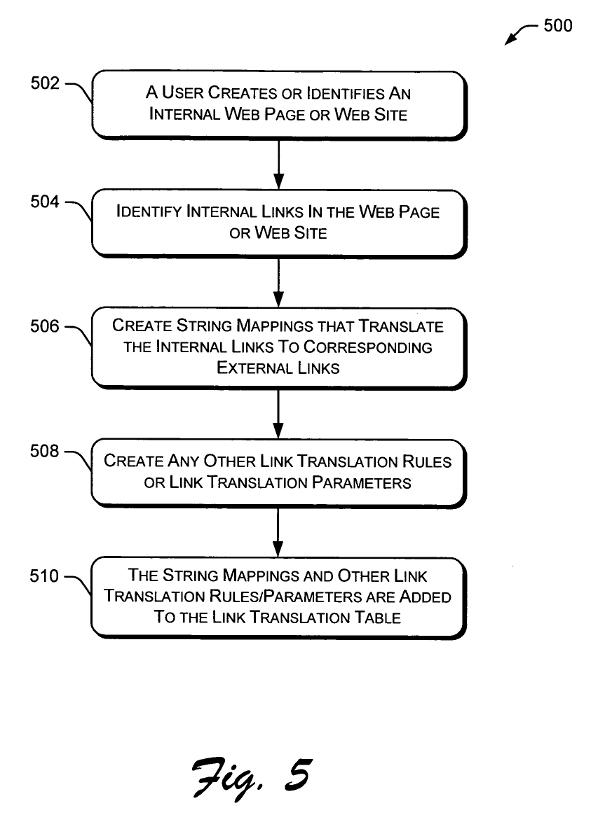

FIG. 5 is a flow diagram illustrating an embodiment of a procedure 500 for adding string mappings and other translation rules or parameters to a link translation table. These mappings may be added by a developer, a network administrator, or other user. Initially, a user creates or identifies an internal web page or web site (block 502). The internal web page or web site is typically accessible via an intranet or other internal network. Additionally, the internal web page or web site may be accessed externally via the Internet or other public network.

Procedure 500 continues by identifying any internal links in the web page or web site (block 504). This identification of internal links can be performed, for example, by a user or by a component, such as a translation module. Next, the procedure creates string mappings that translate the internal links to corresponding external links (block 506). The string mappings may include an entire link or a portion of a link. Example string mappings include protocol translations, server name translations, path name translations, and the like. Additional mappings include inserting a server name into a link, inserting information into a link and deleting information from a link. Procedure 500 continues by creating other link translation rules or link translation parameters, if necessary (block 508). These link translation rules/parameters include, for example, mapping a port number associated with an internal link to a different port number in the external link. The creation of string mappings and other link translation rules/parameters can be performed, for example, by a user or by a component, such as a translation module. Finally, the string mappings and other link translation rules/parameters are added to a link translation table (block 510) for use in translating internal links to external links.

The procedure of FIG. 5 can be performed each time a new web page or web site is created or added to a server, such as a web server. Additionally, the procedure of FIG. 5 can be performed when initializing a new server, when establishing a new network (e.g., an internal network or an external network), or when adding functionality that permits external application programs or devices to access existing internal web pages or web sites.

In a particular embodiment, a configuration application or configuration module assists an administrator with creating and storing link translation information in the link translation table. For example, the configuration application may request one or more of the following: the computer name or internal IP address that is being published (e.g., made available externally via the Internet), a public domain name associated with the internal IP address, a particular folder associated with the public domain name, IP addresses and ports on which the translation module “listens” for incoming web requests, absolute links (or absolute URLs) to replace, and partial links to replace (e.g., strings representing a portion of a link). The various link translation mappings, rules and parameters may be applied to selected users requesting internal web pages. For example, link translation may be performed for a request from a particular user, but such link translation may be denied for a similar request from a different user. After an administrator provides information to the configuration application, appropriate entries are created and stored in the link translation table.

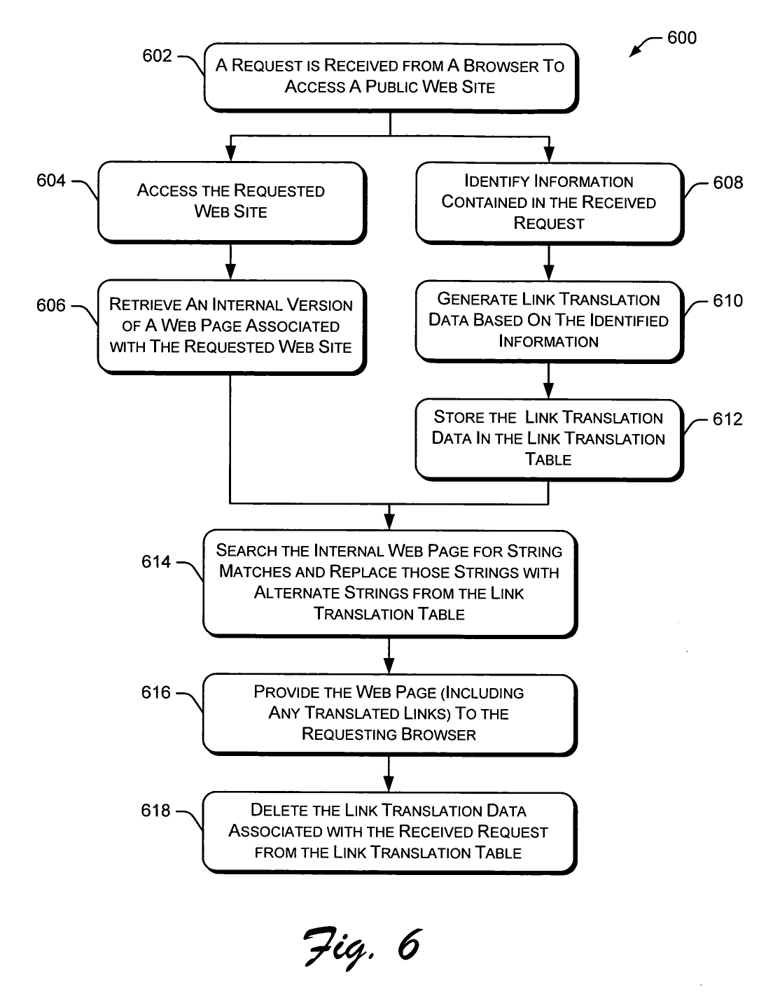

FIG. 6 is a flow diagram illustrating an embodiment of a procedure 600 for translating links associated with one or more internal web pages or web sites. Initially, a request is received from an application program (such as a browser) or other device to access a public web site (block 602). The received request may identify a web site (e.g., a home page for the web site) or a particular web page associated with a web site. Procedure 600 then performs two groups of operations simultaneously. In one group of operations, the procedure accesses the requested web site (block 604) and retrieves an internal version of a web page associated with the requested web site (block 606). In a second group of operations, the procedure identifies information contained in the received request (block 608). This information includes, for example, links contained in the request and tags that identify one or more links. Additionally, information may be retrieved from header information associated with the received request.

An example of information that can be retrieved from a request is provided below.

GET/HTTP/1 .1
Accept: image/gif, image/x-xbitmap, image/jpeg, image/pjpeg,

application/vnd.ms-excel, application/vnd.ms-powerpoint,
application/msword, application/x-shockwave-flash, */*

Accept-Language: en-us
Accept-Encoding: gzip, deflate
User-Agent: Mozilla/4.0 (compatible; MSIE 6.0; Windows NT 5.1; .NET

CLR 1.1.4322)

Host: www.abc123.com
Connection: Keep-Alive

In the above example, the host is identified as “www.abc123.com”. In this example, a translation module (or other link translation device or algorithm) is configured to redirect requests for “www.abc123.com” to an internal server named “abcweb”. Thus, when the above information is retrieved from the request, an entry is added to the link translation table indicating a translation from “abcweb” “www.abc123.com”.

Referring again to FIG. 6, procedure 600 continues by generating link translation data based on the identified information (block 610). Next, the procedure stores the link translation data in the link translation table (block 612). When the two groups of operations are completed, procedure 600 searches the internal web page for string matches (or other link translation rule/parameter matches) and replaces those strings with alternate strings from the link translation table (block 614). The procedure then provides the web page data (including any translated links) to the requesting browser (block 616). At this point, any links displayed in the web page on the browser have been translated into public links (i.e., external links) that can be accessed by the browser via the Internet. Finally, procedure 600 deletes the link translation data associated with the received request from the link translation table (block 618). Any user-defined data contained in the link translation table is maintained for processing future internal links. Additionally, any link translation data associated with other requests from browsers is maintained in the link translation table until processing of the other requests is completed.

When searching internal web pages for links that match entries in the link translation table, the various entries in the link translation table are processed in a particular order. In one embodiment, user-defined string mappings or other link translation rules/parameters are searched and applied prior to string mappings or other link translation rules/parameters generated by the translation module. Thus, user-defined mappings, rules and parameters have a higher priority than translation module-generated mappings, rules and parameters. In another embodiment, the string mappings and other rules/parameters contained in the link translation table are searched and applied in the order listed in the link translation table. In this embodiment, mappings, rules and parameters at the “top” of the link translation table (e.g., the top rows shown in FIG. 4) have a higher priority than mappings, rules and parameters located “lower” in the link translation table. In other embodiments, alternate procedures are used to determine an order for searching and applying the various entries in the link translation table.

Certain types of data requested by a browser may not be searched for links requiring translation. For example, pictures, video data and audio data are not generally searched for internal links needing translation. Additionally, certain types of response codes (or return codes) are not translated. For example, a response having a return code of 206 is not translated. This return code implies a successful response for a request for only a portion of a document (e.g., range request). In this situation, the translation module or other component does not have enough information to know whether there may have been links (or portions of links) that were cut-off at the beginning or end of the portion of the document contained in the response. In another embodiment, the translation module requests that the web server send back a larger portion of the document (e.g., a larger range) to better determine whether any links were cut-off. An alternative embodiment may go ahead and perform the translation, even if the portion of the document contained in the response may include one or more links that were cut-off.

Additional return codes that may cause a particular response not to be translated are: return code 204 (no content), return code 304 (not modified), and return codes greater than 100 and less than 200 (informational return codes).

In particular embodiments, an administrator or other user can determine the type of data that is searched for internal links. For example, an administrator can determine whether to search the following types of data for internal links: applications, application data files, audio data, compressed files, documents (e.g., word processing documents), HTML documents, images (e.g., pictures), macro documents, text, video data, and VRML (Virtual Reality Modeling Language).

Particular examples discussed herein refer to translating internal network links to external links accessible via the Internet or other public network. However, the systems and methods discussed herein can also be used in other environments, such as scanning XML content and translating other types of network traffic using any type of naming format.

In one embodiment, a translation tool (e.g., an application program) or other component may be implemented as an ISAPI (Internet Server API) filter. The translation tool monitors outgoing data from, for example, a publishing proxy to a client, and modifies links contained in the data. The translation tool can be configured to translate links in certain types of documents. For example, links in text and html documents may be translated, whereas links in application programs or Java scripts are not translated. Additionally, if a response does not have a content-type header (or if the content type cannot be translated), the translation tool tries to infer the content type based on the file extension or other information in the response. If no type is determined or inferred, the response may be sent without any translation.

If the response has a transfer-encoding header with a value equal to “chunked”, the response is sent in chunked transfer-encoding without accumulating. Additionally, if the response has a content-length header and the client utilizes HTTP 1.1 or higher, the response is sent in chunked transfer-encoding without accumulating. But, if the response has a content-length header and the client does not utilize HTTP 1.1 or higher, the response is accumulated, translated, and sent using the appropriate content length. In a particular embodiment, the response is accumulated if the size does not exceed a threshold. If the size does exceed the threshold, the response is not accumulated. When the size exceeds the threshold, the content-length header is removed, the response is sent, and the connection is closed after the entire response is sent. If the response does not have a content-length header, the response is translated “on the fly” without accumulating.

FIG. 7 illustrates a general computer environment 700, which can be used to implement the techniques described herein. The computer environment 700 is only one example of a computing environment and is not intended to suggest any limitation as to the scope of use or functionality of the computer and network architectures. Neither should the computer environment 700 be interpreted as having any dependency or requirement relating to any one or combination of components illustrated in the example computer environment 700.

Computer environment 700 includes a general-purpose computing device in the form of a computer 702. One or more media player applications can be executed by computer 702. The components of computer 702 can include, but are not limited to, one or more processors or processing units 704 (optionally including a cryptographic processor or co-processor), a system memory 706, and a system bus 708 that couples various system components including the processor 704 to the system memory 706.

The system bus 708 represents one or more of any of several types of bus structures, including a memory bus or memory controller, a point-to-point connection, a switching fabric, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 702 typically includes a variety of computer readable media. Such media can be any available media that is accessible by computer 702 and includes both volatile and non-volatile media, removable and non-removable media.

The system memory 706 includes computer readable media in the form of volatile memory, such as random access memory (RAM) 710, and/or non-volatile memory, such as read only memory (ROM) 712. A basic input/output system (BIOS) 714, containing the basic routines that help to transfer information between elements within computer 702, such as during start-up, is stored in ROM 712. RAM 710 typically contains data and/or program modules that are immediately accessible to and/or presently operated on by the processing unit 704.

Computer 702 may also include other removable/non-removable, volatile/non-volatile computer storage media. By way of example, FIG. 7 illustrates a hard disk drive 716 for reading from and writing to a non-removable, non-volatile magnetic media (not shown), a magnetic disk drive 718 for reading from and writing to a removable, non-volatile magnetic disk 720 (e.g., a “floppy disk”), and an optical disk drive 722 for reading from and/or writing to a removable, non-volatile optical disk 724 such as a CD-ROM, DVD-ROM, or other optical media. The hard disk drive 716, magnetic disk drive 718, and optical disk drive 722 are each connected to the system bus 708 by one or more data media interfaces 725. Alternatively, the hard disk drive 716, magnetic disk drive 718, and optical disk drive 722 can be connected to the system bus 708 by one or more interfaces (not shown).

The disk drives and their associated computer-readable media provide non-volatile storage of computer readable instructions, data structures, program modules, and other data for computer 702. Although the example illustrates a hard disk 716, a removable magnetic disk 720, and a removable optical disk 724, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on the hard disk 716, magnetic disk 720, optical disk 724, ROM 712, and/or RAM 710, including by way of example, an operating system 726, one or more application programs 728, other program modules 730, and program data 732. Each of such operating system 726, one or more application programs 728, other program modules 730, and program data 732 (or some combination thereof) may implement all or part of the resident components that support the distributed file system.

A user can enter commands and information into computer 702 via input devices such as a keyboard 734 and a pointing device 736 (e.g., a “mouse”). Other input devices 738 (not shown specifically) may include a microphone, joystick, game pad, satellite dish, serial port, scanner, and/or the like. These and other input devices are connected to the processing unit 704 via input/output interfaces 740 that are coupled to the system bus 708, but may be connected by other interface and bus structures, such as a parallel port, game port, or a universal serial bus (USB).

A monitor 742 or other type of display device can also be connected to the system bus 708 via an interface, such as a video adapter 744. In addition to the monitor 742, other output peripheral devices can include components such as speakers (not shown) and a printer 746 which can be connected to computer 702 via the input/output interfaces 740.

Computer 702 can operate in a networked environment using logical connections to one or more remote computers, such as a remote computing device 748. By way of example, the remote computing device 748 can be a personal computer, portable computer, a server, a router, a network computer, a peer device or other common network node, game console, and the like. The remote computing device 748 is illustrated as a portable computer that can include many or all of the elements and features described herein relative to computer 702.

Logical connections between computer 702 and the remote computer 748 are depicted as a local area network (LAN) 750 and a general wide area network (WAN) 752. Such networking environments are commonplace in offices, enterprise-wide computer networks, intranets, and the Internet.

When implemented in a LAN networking environment, the computer 702 is connected to a local network 750 via a network interface or adapter 754. When implemented in a WAN networking environment, the computer 702 typically includes a modem 756 or other means for establishing communications over the wide network 752. The modem 756, which can be internal or external to computer 702, can be connected to the system bus 708 via the input/output interfaces 740 or other appropriate mechanisms. It is to be appreciated that the illustrated network connections are exemplary and that other means of establishing communication link(s) between the computers 702 and 748 can be employed.

In a networked environment, such as that illustrated with computing environment 700, program modules depicted relative to the computer 702, or portions thereof, may be stored in a remote memory storage device. By way of example, remote application programs 758 reside on a memory device of remote computer 748. For purposes of illustration, application programs and other executable program components such as the operating system are illustrated herein as discrete blocks, although it is recognized that such programs and components reside at various times in different storage components of the computing device 702, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a request for an internal web page from an external browser application;
identifying at least one internal link in the internal web page;
modifying the at least one internal link such that the internal link is accessible by the external browser application; and
communicating the requested web page, including the modified internal link, to the external browser application.

2. A method as recited in claim 1 wherein modifying the at least one internal link includes modifying a portion of a uniform resource locator associated with the at least one internal link.

3. A method as recited in claim 1 wherein modifying the at least one internal link includes modifying a protocol associated with the at least one internal link.

4. A method as recited in claim 1 wherein modifying the at least one internal link includes modifying a port associated with the at least one internal link.

5. A method as recited in claim 1 wherein modifying the at least one internal link includes modifying a server name associated with the at least one internal link.

6. A method as recited in claim 1 wherein the request for an internal web page is received via the Internet.

7. A method as recited in claim 6 wherein the internal web page is stored on a server coupled to an internal network.

8. A method as recited in claim 1 wherein modifying the at least one internal link includes accessing string mappings from a link translation table and applying the string mappings to the at least one internal link.

9. A method as recited in claim 1 further comprising:
identifying link information contained in the request for an internal web page; and
storing the identified link information in a link translation table.

10. A method as recited in claim 9 further comprising deleting the identified link information from the link translation table after communicating the requested web page to the external browser application.

11. One or more computer-readable memories containing a computer program that is executable by a processor to perform the method recited in claim 1.

12. A method comprising:
receiving a request for an internal web page from an external source;
identifying link information contained in the request for an internal web page;
storing the identified link information in a link translation table;
retrieving the internal web page;
translating any internal links in the internal web page such that the internal links are accessible by the external source; and
communicating the internal web page, including the translated internal links, to the external source.

13. A method as recited in claim 12 wherein translating any internal links in the internal web page includes accessing data contained in the link translation table.

14. A method as recited in claim 13 wherein the link translation table includes at least one entry defined by a user.

15. A method as recited in claim 12 wherein identifying link information contained in the request includes identifying data in a header associated with the request.

16. A method as recited in claim 12 further comprising deleting the identified link information from the link translation table after communicating the internal web page to the external source.

17. A method as recited in claim 12 wherein the request for an internal web page is received via a public network and wherein the internal web page is stored on a server coupled to a private network.

18. One or more computer-readable memories containing a computer program that is executable by a processor to perform the method recited in claim 12.

19. A system comprising:
a link translation table; and
a translation module coupled to the link translation table, wherein the translation module is to receive a request for an internal web page and to identify any internal links in the requested internal web page, wherein the translation module further modifies any internal links using data contained in the link translation table and generates the requested web page data, including the modified internal links, for communication to a source of the internal web page request.

20. A system as recited in claim 19 wherein the system is contained in a firewall, wherein the firewall is coupled between a public network and an internal network associated with the internal web page.

21. A system as recited in claim 19 wherein the system is contained within a web server.

22. A system as recited in claim 19 further comprising a configuration module coupled to the translation module, wherein the configuration module permits editing of data contained in the link translation table.

23. A system as recited in claim 19 wherein the link translation table contains mappings of portions of links between internal links and external links, wherein internal links are accessible by an internal device coupled to an internal network and external links are accessible by an external device coupled to an external network.

24. A system as recited in claim 19 wherein the link translation table contains at least one user-defined entry and at least one entry generated by the translation module in response to the request for an internal web page.

25. One or more computer-readable media having stored thereon a computer program that, when executed by one or more processors, causes the one or more processors to:
receive a request for an internal web page via a public network;
retrieve the requested internal web page;
determine whether the internal web page contains any internal links;
if the internal web page contains at least-one internal link:
modify the at least one internal link such that the internal link is accessible via the public network; and
generating data representing the requested internal web page, wherein the generated data includes the modified internal link.

26. One or more computer-readable media as recited in claim 25 wherein the request for an internal web page is received via the Internet from a web browser application.

27. One or more computer-readable media as recited in claim 25 wherein the at least one internal link is modified by accessing link translation data contained in a link translation table.

28. One or more computer-readable media as recited in claim 25 wherein the one or more processors further modify the at least on internal link using information contained in a header associated with the received request for an internal web page.

29. An apparatus comprising:
means for receiving a request for a web page associated with an internal network; and
means for translating internal links contained in the web page, wherein the internal links are accessible via the internal network, and wherein the means for translating translates any internal links contained in the web page into external links that are accessible via an external network.

30. An apparatus as recited in claim 29 further comprising means for communicating web page data, including any translated links, to a source of the request for the web page.

31. An apparatus as recited in claim 29 wherein the means for translating translates internal links by modifying a portion of a uniform resource locator associated with the internal links.

32. An apparatus as recited in claim 29 wherein the means for translating translates internal links by replacing a first uniform resource locator associated with the internal links with a second uniform resource locator associated with external versions of the internal links.

33. An apparatus as recited in claim 29 wherein the means for translating translates internal links by replacing a first protocol designator with a second protocol designator.

34. An apparatus as recited in claim 29 wherein the means for translating translates internal links by replacing a first server name associated with the internal links with a second server name associated with external versions of the internal links.

35. An apparatus as recited in claim 29 further comprising means for storing link translation data, wherein the means for storing link translation data is coupled to the means for translating internal links.

36. An apparatus as recited in claim 35 wherein the means for storing link translation data contains portions of internal links and corresponding portions of external links.

37. An apparatus as recited in claim 35 wherein the means for storing link translation data contains internal port numbers and corresponding external port numbers.
